(19) United States
(12) Patent Application Publication
(10) Pub. No.: US 2007/0219782 A1
(43) Pub. Date: Sep. 20, 2007

(54) User-supported multi-language online dictionary

(76) Inventor: Qing Li, Austin, TX (US)

Correspondence Address: Qing Li, 8337 Alvin High Lane, Austin, TX, 78729, US

(21) Appl. No.: 11/374,941

(22) Filed: Mar. 14, 2006

(51) Int. Cl. G06F 17/21

(52) U.S. Cl. 704/10

(57) ABSTRACT

This invention describes an electronic dictionary that is built and maintained by the user community. It is a single source to translate any word from any language into any other language. The dictionary resides with an online server. User with online connection specifies his/her native language and looks up any correct word, misspelled word, acronym, or phrase of any foreign language. The definitions and related information are also supplied by the user community. A user can also place advertisement. He/she can associate the advertisement with the entries in the dictionary. While the dictionary content is user maintained, the administrator has the full control.

### BACKGROUND OF THE INVENTION

1. Technical Field

The present invention relates to the field of information processing, more specifically, to an electronic dictionary that is maintained and used by the user community. The dictionary lets a user look up the native language definition of any foreign word.

2. Description of Related Art

The present invention helps people understand a foreign word, an acronym, a short phrase, or any other media that can be encoded as a sequence of bytes, which is simply called word in this document. The word may be in any foreign language. The word might not be collected by any published dictionary for various reasons: it may be too new, too parochial, used by too few people, etc. The goal of the invention is that people encounter it can understand its basic meaning and continue his/her activities. The dictionary is community-updated. Although it may not have authentic definitions, it provides enough clues for a user to find the details from other sources.

More and more people around the world with different native languages are joining the Internet. Inevitably people will encounter unknown words while staying active on the Internet. People need to understand them to best continue their activities. One way to understand them is to look them up, either offline or online. There are many online dictionaries and encyclopedias.

Online dictionaries and encyclopedias are basically online versions of their paper counterparts. They provide a good source. There are two types of dictionaries, general ones that cover every aspects of life and specific ones that cover one domain of study. The former can not collect all words due to the volume of words. In many cases the word to be looked up can only be found in the latter. While the user gets “undefined” return from the former, he/she does not know which one of the latter to look up. So in many times a user cannot find the definitions even with the help of dictionaries. Due to the process how a new word is collected by a dictionary, it takes a long time since its inception for it to show up in any dictionaries. However, new words are mostly looked up by people who already understand “old” words. With the popularity of Internet, new words related to it are created almost daily. People not close with online chat room have hard time understanding all those acronyms. Besides, there are many words that may never be collected by a dictionary. Examples are words that become a fad then fade away soon, words that are used only by a parochial community, and acronyms or short phrases that are not considered worthy of dictionary entries by linguists.

People who create new words or use new words in a daily basis are the best source for their definitions. A dictionary that can be quickly updated by them will provide fast information for people who do not understand them. And in many occasions people looking up a word do not necessarily want to know the detailed definition. They are happy as long as their task at hand is not handicapped by the unknown word. We do not necessary need a linguist.

The Wikipedia community (http://www.wikipedia.org) is a good example of community supported knowledge base. Users contribute to the definition of word items. But its goal is to match the authenticity of other encyclopedias. The problems discussed above still exist.

A major problem this invention addresses is for people to look up words of a foreign language. The online language-to-language dictionaries are a very small set of all online dictionaries. This further frustrates online users of native languages other than English. The Wikipedia community has also started to create language-to-language dictionaries. Again, its goal is to match authentic counterparts. And we only see those for specific domains. We expect to see every language in the world showing up on the Internet. More and more people will encounter more and more foreign words on the Internet. It will be a problem for a user even to find the right dictionary to look up foreign words. The user may not even know what language an unknown word belongs to.

The goal of this invention is to provide a community-based online dictionary that a user of any native language can look up any words of any foreign language. An undefined word will be log by the dictionary and can be defined by other users later. This dictionary does not claim authentic definitions, although this should be the goal of the user community. The dictionary should provide the user enough information to continue his/her activities or know where to look further.

Google (http://www.google.com) allows the user to look up words or phrases such as typing “define tag” to find the definition of “tag”. This, however, depends on that a definition exists on the Web and that the definition is processed by the Google engine. Besides, it is still hard for people to find the definition in his/her native language.

It is common now for webpage to display advertisement. The information of many advertisements is also related to the content of the webpage. For example, a home improvement website may carry advertisement of companies that sell home building material. Google also allows companies to bid on the search words. This invention goes a step further to attach advertisement with dictionary content, including the words, the language, etc.

3. Description of Related Patents

U.S. Pat. No. 6,708,311 described a method to help user to understand technical documents. In it a document is automatically scanned for unknown words and the user who provides the document also provides spell checks and definitions to the dictionary. This invention is mentioned here because its dictionary definitions are also provided by the user. But the new words are not provided by the users, and the purpose of the dictionary is not used for lookup. Besides, its dictionary does not accept incorrect word, whose definition can point to its correct version.

United States Patent Application 20010056352 also aims to help a reader of foreign language documents. Its dictionary is not maintained by the user community. It does not address the problem we discussed.

United States Patent Application 20020194300 also aims to help a user understand web pages in foreign languages. The invention provides translation from any language to any language. But it does not have its own dictionaries and its dictionary definitions are not supplied by the user community.

United States Patent Application 20020198699 is another method to help user understand documents in other languages. The server receives document translation from a user and another user can download the translation for viewing. This invention is mentioned here because it provides a means for the user to contribute. But it is no a dictionary and its purpose and workings serve a different goal.

United States Patent Application 20030023424 is yet another online dictionary that allows different forms of request and can translate from any language to any language. But again its dictionary is not user supported. And it interacts with the user through a special means.

United States Patent Application 20040117774 provides different entries for different variations of a word caused by case or orthographic variations. However, this invention does not allow entries of incorrectly spelled words. Again, its dictionary is not user supported.

United States Patent Application 20040243396 describes an electronic dictionary that a user can modify its entries. However, it applies to a single user rather than a user community. It is mainly an authentic dictionary with some updates from the user.

United States Patent Application 20050075858 provides another community based dictionary in which the translation of a word is fixed by the selected moderator of the community. However, the words of the dictionary are not provided by the user community. It requires a selected community and selected moderator, who are normally not the users of the dictionary. It also only addresses translating from one language to one language.

### OBJECTS AND ADVANTAGES

Accordingly, several objects and advantages of this invention are:
1. The dictionary is a single source to translate any word from any language into any other language.
2. The user will find from this dictionary definitions that may not be found from other sources. Because the dictionary is user updated, new words will show up here faster than ordinary dictionaries.
3. The definitions are provides by people who know the words. A user not finding the definition is allowed to supply some of his/her guesswork that will help others looking up the same word.
4. User can look up words without knowing its language. We put all foreign words in the same dictionary for a native language.
5. The dictionary collects entries for words with typo or word that the user is not sure. The definition of those words will hopefully suggest the correct words. In many times, a user looking up a word may not remember the correct spellings, or the word he/she reads is spelled wrong. Not all standard dictionaries could help a user in this situation.
6. It links relevant target user to the advertisements. Because the dictionary will collect most up-to-date words which are in fashion, people will be willing to associate advertisement with those words.

Further objects and advantages of my invention will become apparent from a consideration of the drawings and the ensuing description.

### SUMMARY OF THE INVENTION

This invention is an online dictionary implemented in software. This invention provides a single source to translate any word from any language into any other language. This invention includes a dictionary database that stores user-provided definitions, a server that manages the database, and a client that interfaces to the user. The dictionary data is organized by target languages. For each target language, records are organized by words. A word can be a word, an acronym, or a short phrase, etc. Each word has zero or more definitions. Each definition has several fields: source language, pronunciation, meaning in source and native language, and discussion log. The database also contains a sponsorship base that stores advertisement information. The advertisement will be part of the definition information returned back to the client.

The server retrieves and updates the dictionary database. It supports word lookup, word definition input, applying for advertisement, and administration.

The client serves as the interface for the user to interact with the database. A user can look up words, input/update definitions, and apply for advertisements. The administrator can also perform administration tasks.

The main usage of the invention is word lookup. The user pre-selects the native language then input the word to look up, or inputs the word and native language at the same time. The server will return all the definitions of the word in the native language. If no definition is available, the item will be inserted into the database as undefined and the definitions for other native language, if exist, will be returned. The display will be in the native language. If no native language is specified in the query, definitions for all native languages will be returned. In this case the display will be in default language, maybe in English. The returned information may also contain advertisements. If the user elect, he/she will feed back with which definition he/she accepts.

If the native language is selected, the user is allowed to add/update definitions for the words in the native language. If a word was accepted for a certain number of consecutive times, the word may not longer be updated. The user is also allowed to log comments in a separate input box. Previous logged comments can also be retrieved.

Another way for the user to provide definition is to request directly undefined items of a native language from the database and then select the words to define.

The administrator can also remove or finalize a definition or comments.

The advertiser can provide a piece of advertisement. He/she can associate it with a native language, or native language and words, or words only, or no association. The advertisement will be assigned a count that is related to the payment. Each time the advertisement is shown to a user, the count decreases by one. The advertisement will no longer be displayed once the count goes to zero. The advertiser can replenish the count by paying more.

### THE EMBODIMENT OF THE INVENTION

This invention can be deployed on a large scale network such as the Internet. The database and server will be hosted at a web address. The client will be the webpage displayed in any web browser such as Internet Explorer from Microsoft or Fire Fox from open source society. This is the preferred embodiment of the invention.

Another possible embodiment can be an Internet website that only serves a single native language. In this case only definitions in the single native language are collected. Yet another possible embodiment of this invention can be a standalone electronic dictionary that a user can carry around. The user then constantly updates the dictionary as he/she moves around over time. The standalone dictionary can also be fixed in a certain location such as public places. Any user can walk to the location and interact with it.

### BRIEF DESCRIPTION OF THE DRAWINGS

These and other objects and features and technical advantages of the present invention will be readily apparent from the following description of the preferred exemplary embodiments of the invention in conjunction with the accompanying drawings, in which

FIG. 1 is a diagram showing the overall components of a first embodiment of the present invention;

FIG. 2 is a diagram showing a tree structure of the dictionary objects;

FIG. 3 is a diagram showing a tree structure of the sponsorship database objects;

FIG. 4 is a diagram showing an example of the client display for the main page, the word lookup page;

FIG. 5 is a diagram showing an example of the client display for word definitions;

FIG. 6 is a diagram showing an example of the client display of words that needs definition;

FIG. 7 is a diagram showing an example of the client display for submitting new word definition;

FIG. 8 is a diagram showing an example of the client display for sponsor login;

FIG. 9 is a diagram showing an example of the client display for the sponsor to create advertisement configuration;

FIG. 10 is the flowchart of overall user interaction with the dictionary;

FIG. 11 is the flowchart of one complete sequence of user looking up the dictionary;

FIG. 12 is the flowchart of one complete sequence of user contributing new definitions;

FIG. 13 is the flowchart of user contributing one definition;

FIG. 14 is the flowchart of a complete sequence of a sponsor access.

### DESCRIPTION OF THE PREFERRED EMBODIMENTS

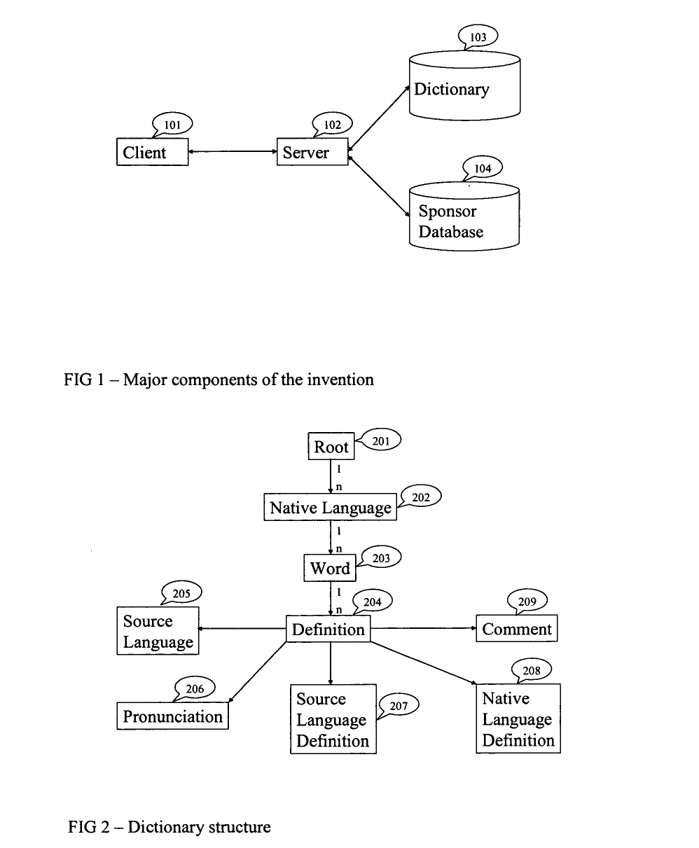

A system according to a first embodiment of the present invention will now be explained referring to FIG. 1 to FIG.14. The system of this embodiment is a web-based version of our electronic dictionary. Any web browser serves as the client. The user interacts with the dictionary through web pages.

The client component 101 in FIG. 1 can be any web browser such as Microsoft Internet Explorer. The server 102 and the databases of dictionary 103 and sponsorship 104 reside at the website. The server 102 and the client 101 communicate via the Internet just like any web browser visiting any website. The server 102 can be implemented in any programming language such as C++, PHP, Ruby, etc. The databases 103/104 can be implemented with any database technology such as Oracle, MySQL, etc. The server 102 accesses the databases 103/104 using related programming methods.

As is depicted in FIG. 2, the dictionary in this embodiment contains a collection of objects in tree structure. There is one Root object 201 that links to Native Language objects 202, one per language. The Native Language object 202 is the root of all objects that serves for the users whose native language is that language. A Native Language object 202 contains a set of Word objects 203. A Word object represents a word. Each Word object contains a set of Definition objects 204. A Definition object 204 serves as one definition of the word in the Word object 203. A Definition object 204 has 5 objects, Source Language 205, Pronunciation 206, Source Language Definition 207, Native Language Definition 208, and Comment 209. The Source Language object 205 stores the language that the word belongs; the Pronunciation object 206 stores how the word is pronounced in its own language; the Source Language Definition 207 objects stores its definition in its own language; the Native Language Definition object 208 stores its definition in the native language; the Comment object 209 stores the comment by the user who provided the definition. A Definition object 204 is considered defined if it has at least information in the Source Language object 205 and Native language definition object 208. The child objects of the Definition object 204 are all versioned, that is, whenever a user updates the definition, it is time-stamped and the old copies of them are archived. This implies that a user can never delete any information from the dictionary. Only the administrator of the website has full control of the dictionary and can delete any objects.

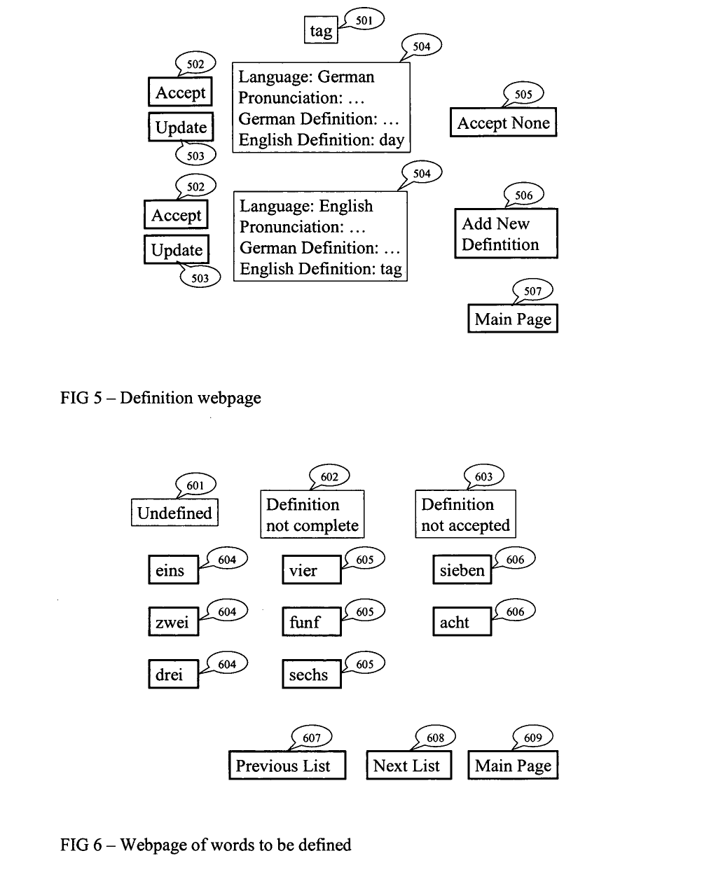

As is mentioned in the background of the invention, the dictionary does not intend to provide users detailed definition of a definition, rather it helps them what they are working on. So there is limit on the size of the user input, including values in the Word object 203, the Source Language Definition object 207, and the Native Language Definition object 208. The user can, however, provide lengthy comments for Comment object 209, which is not displayed on the word definition web page described in FIG. 5.

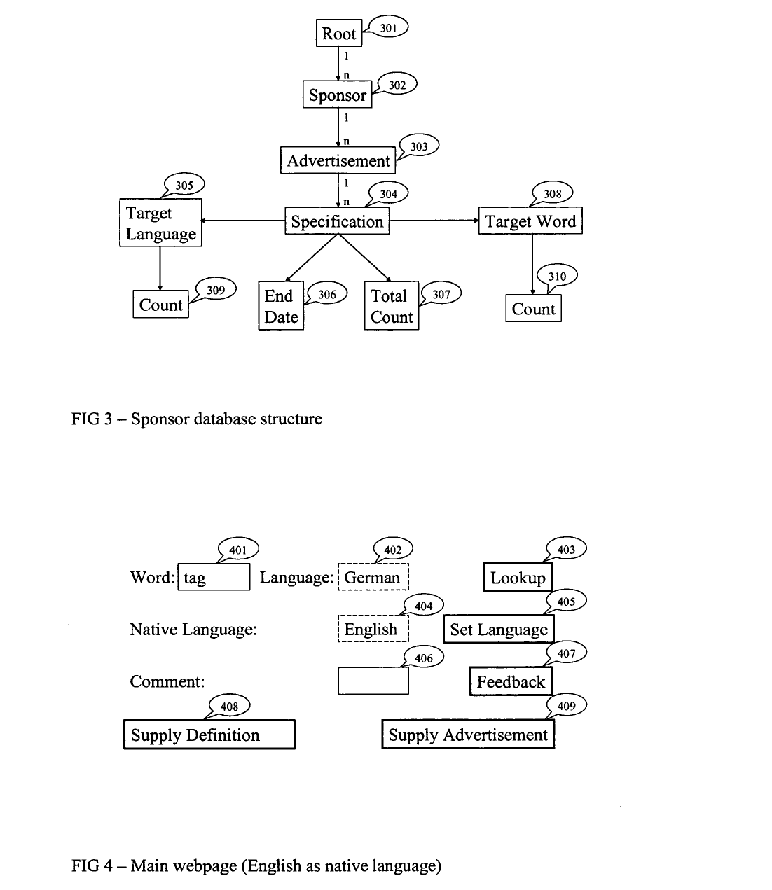

As is depicted in FIG. 3, the Sponsor database in this embodiment contains a collection of objects in tree structure. There is one Root object 301 that links to Sponsor objects 302, one per sponsor. The Sponsor object 302 contains sponsor information and has a list of Advertisement objects 303. An Advertisement object 303 defines an advertisement that can be displayed on the webpage returned to the user. It may contain a link to the sponsor's website. The Advertisement object 303 contains a list of Specification objects 304. A Specification object defines when and how the advertisement is displayed. The Specification object 304 contains a Target Language object 305, an End Date object 306, a Total Count object 307, and a Target Word object 308. The Target language object 305, if it has value, specifies that the advertisement is only displayed when a user's native language is the target language; the End Date object 306, if it has value, specifies that the advertisement will not longer be displayed after the end date; the Total Count object 307 specifies how many times the advertisement will be displayed; the Target Word object 308, if it has value, specifies with which word the advertisement must be displayed. Both Target Language object 305 and Target Word object 308 have a Count object 309/310 that specifies at least how many times the advertisement must be displayed for the target language or word. Again, a user can never delete any information from the database. Only the administrator of the website has full control of the database and can delete any objects.

Note the information described in FIG. 2 and FIG. 3 are not necessarily needed to be stored as tree structures. They can be saved in relational database tables. The only requirement is that the information in FIG. 2 and FIG. 3 are stored in the database.

FIG. 10 is the overall flowchart of the client server interaction in this embodiment. When a user types in the dictionary website in the browser's address line, the initial lookup main page as described in FIG. 4 is returned to the user's browser. Unless the user specifies the native language in the web address, the main page of the default language is returned to the user. The user can switch native language from the main page by selecting the native language from the language list selection 404 and click on the “Set Language” button 405, which will retrieve a main page in the selected native language. From this point on all subsequent web pages will be written in the native language. The page design will still be the same among different native languages. English is used as the default language here. What is described in the following will be the same for other languages except that the web page shown to the user will be written in a different language.

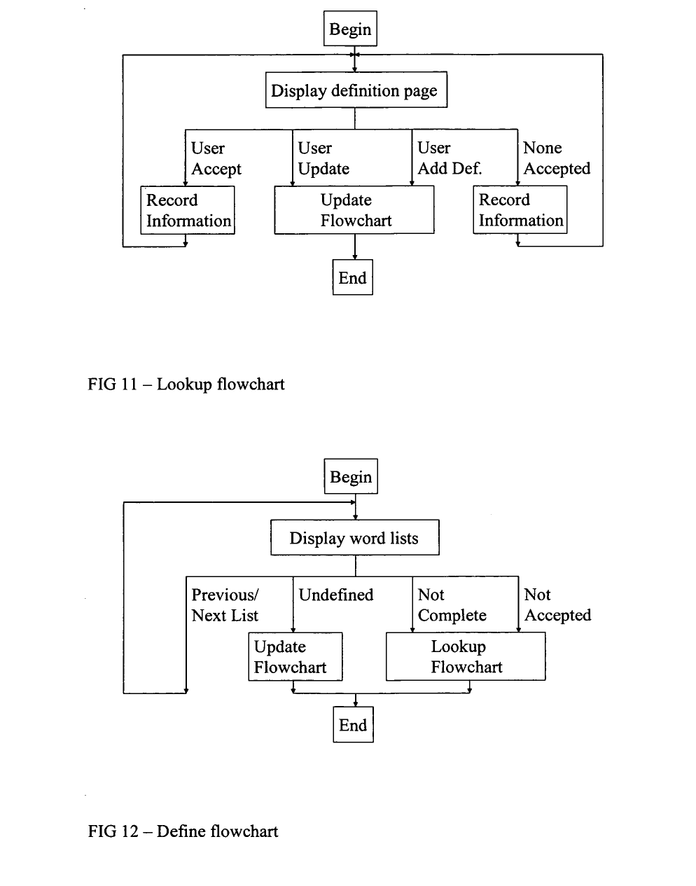

The major use of the dictionary will be word lookup. The user types in the word in the edit box 401 where the word “tag” is shown in FIG. 4. If the user knows the language of the word, he/she can select the language from the list 404 where “German” is shown in FIG. 4. If the user does not know the language, he/she leaves the list box 404 empty. Then the user clicks on the “Lookup” button 403 to look up the word and the flow goes to the lookup flowchart in FIG. 11, which shall be described later.

From the main page the user can also provide feedback to the administrator by input the feedback to the edit box 406 and click on the “Feedback” button 407. The feedback will be stored and read by the administrator. The user stays with the main page after feedback.

Two major activities are also launched from the main page. By clicking on the “Supply Definition” button 408, the user proceeds to the activities described in the define flowchart in FIG. 12, which will be described later; by clicking on the “Supply Advertisement” button 409, the user proceeds to the activities described in the advertise flowchart in FIG. 14, which will be described later. The user must have selected a native language to supply definition.

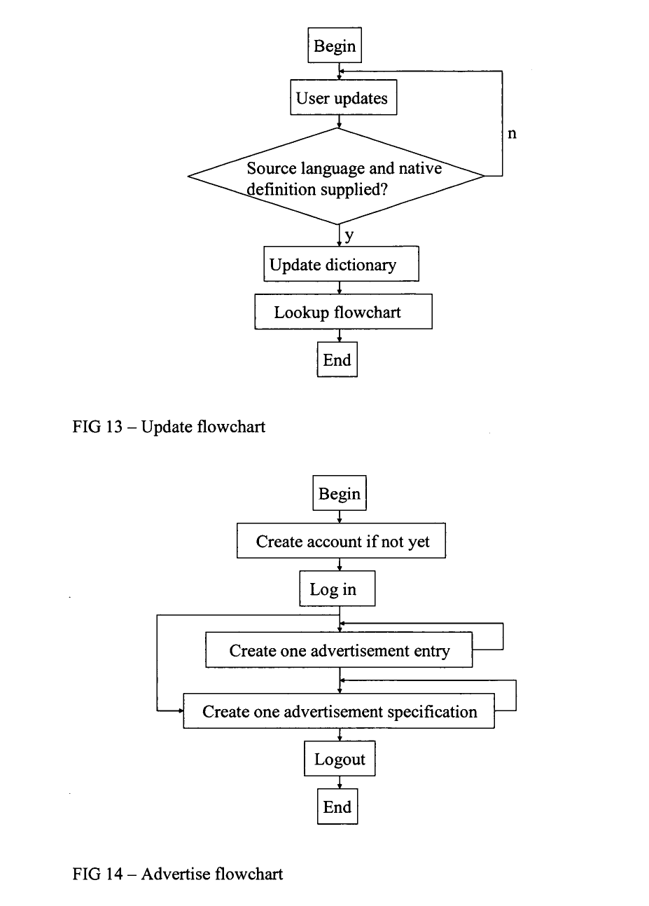

FIG. 11 is the flowchart in this embodiment when the user is presented a word definition page, an example of which is shown in FIG. 5. A list of definitions 504 for the word will be displayed. Each definition has associated two buttons, “Accept” button 502 and “Update” button 503. The definition displays all information of the Definition object 204 in FIG. 2 for the user's native language except the comment 209 which is not necessary. By clicking on the “Accept” button 502, the user indicates that this definition meets his/her need. This will be recorded by the dictionary. By clicking on the “Update” button 503, the user indicates that he/she wants to update this definition, and he/she will be directed to the activities described later in the update flowchart in the FIG. 13.

The dictionary does not use language specific information such as case, tense, and other orthographic variations for comparison. Different spellings will be recorded as different Words 203. Their definitions, which are provided by the user, can be independent or can cross reference each other.

There are three other buttons not related to a single definition, “Accept None” 505, “Add New Definition” 506, and “Main Page” 507. If the user clicks on the “Accept None” button 505, he indicates that none of the displayed definitions meet his/her need. This will be recorded by the dictionary. If the user clicks on the “Add New Definition” button 506, he intends to create a new definition and he/she will be directed to the activities described later in the update flowchart in the FIG. 13. If the user clicks on the “Main Page” button 507, the main page will be returned to the browser.

A definition 504 can be pinned down, which means the definition is finalized and can no longer be changed. In this case the “Accept” button 502 and “Update” button 503 will be disabled. Rules can be devised to pin a definition based on user feedback. For example if a definition is accepted consecutively for certain counts, then it is pinned down. The administrator can also pin a definition.

If no definition is found for the word, the word will be added to the dictionary and the user will receive a page without any definition. However, if definitions for the word in other native languages exist, they will be displayed as well. If the user does not specify native language, definitions for the word in all languages, if they exist, will be displayed. Only the “Add New Definition” 506 and “Main Page” 507 buttons will be displayed in cases described in this paragraph.

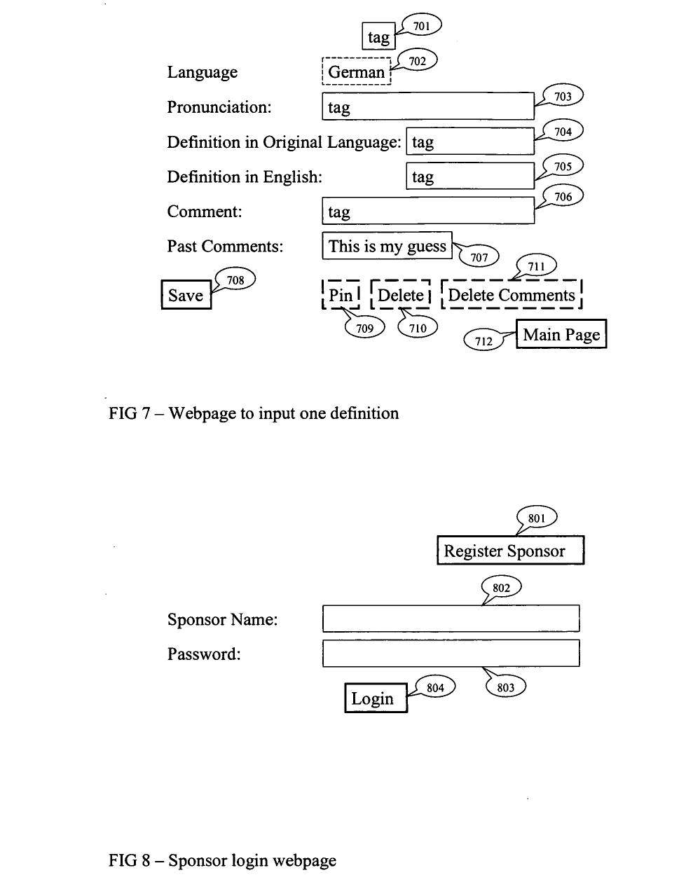

FIG. 12 is the flowchart in this embodiment when the user decides to contribute definitions for the existing words in the dictionary. He/she does this by clicking on the “Supply Definition” button 408 on the main page in FIG. 4. The server will return a page of the word lists as is shown in FIG. 6. Three lists of words are displayed, the ones that are not defined yet 601, the ones that are defined but not complete 602, and the ones whose definitions are not accepted by users 603. As is explained for FIG. 2, a word is defined if the Definition object 204's Source Language object 205 and Native Language definition object 208 both have values. A word definition is complete if all the child objects of the Definition object 204 have values. If the user clicks on any of the words 604 in the list of undefined 601, the server will return the update page for the word as described in FIG. 7 and the user proceeds to the activities as described in the update flowchart in FIG. 13, which shall be described later. If the user clicks on any of the words 605 in the list of not complete 602, the server will return the definition page for the word as described in FIG. 5 and the user proceeds to the activities as described in the lookup flowchart in FIG. 11, which is already described. If the user clicks on any of the words 606 in the list of not accepted 603, the server will return the definition page for the word as described in FIG. 5 and the user proceeds to the activities as described in the lookup flowchart in FIG. 11, which is already described. Normally the page only displays a subset of all the words in the lists, the user can turn to the next subset or previous subset by clicking on the “Next List” button 608 and “Previous List” button 607. And finally, the user can click on the “Main Page” button 609 to return to the dictionary main page.

FIG. 13 is the flowchart in this embodiment when the user updates one definition. The sample page displayed is shown in FIG. 7. On this page, the word 701 and past comments 707 on the word are displayed. The user can type in values for the source language 702, pronunciation 703, definition in source language 704, definition in native language 705, and comment 706. These correspond to 5 child objects 205/206/207/208/209 of the Definition object 204 described in FIG. 2. The user can click on the “Save” button 708 to upload his/her change to the dictionary. If the language field 702 or the definition in native language 705 has no value, the user cannot save. In FIG. 7 the native language is English. Once the definition is saved, the server will return the definition page as shown in FIG. 5 back to the client browser. Three buttons will be displayed if the user is the administrator: “Pin” button 709 to pin down the definition, “Delete” button 710 to delete the definition from the dictionary, and “Delete Comment” button 711 to delete the comments from the dictionary. Once the definition is pinned, user can no longer update it. The user can also go back to the main page by clicking on the “Main Page” button 712.

In the beginning, the administrator can pre-populate the dictionary with definitions and undefined words to make it more useful.

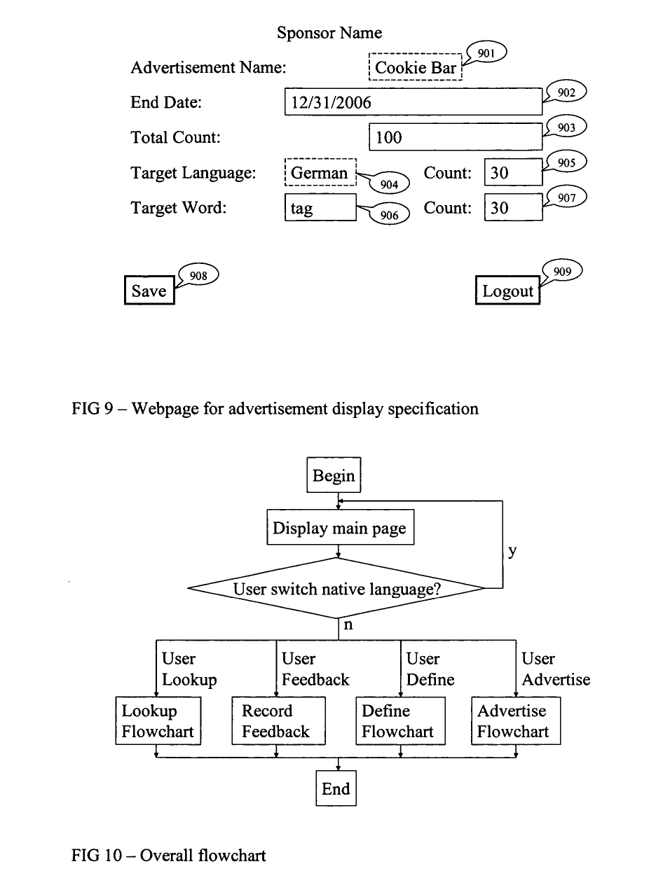

FIG. 14 is the flowchart in this embodiment when a sponsor accesses the website. The sponsor does this by clicking on the “Supply Advertisement” button 409 in the main page shown in FIG. 4. The login page will be returned to the client browser as is shown in FIG. 8. In FIG. 8 the sponsor clicks the “Register Sponsor” button 801 to create a new sponsor account. An existing sponsor simply logs in by clicking “Login” button 804 after typing in the sponsor name 802 and password 803. After login, the sponsor can provide one or more advertisement displays, which can be included in web pages returned to other users. The size of an advertisement display is limited. The sponsor then can specify how and when the advertisement can be displayed. An advertisement can have one or more specifications 304 as is described in FIG. 3. One specification is provided through the webpage as shown in FIG. 9. The sponsor types in end date 902, total count 903, target language 904 and count 905, target word 906 and count 907. These correspond to the objects 306/307/305/309/308/310 described in FIG. 3. By clicking on “Save” button 908, the sponsor saves the specification in the sponsor database. By clicking on “Logout” button 909, the sponsor logs out.

Once the sponsor has paid the fee, the advertisement will be displayed according to the specifications. If the specification specifies target language, the advertisement will be displayed when a user's native language is the target language; if the specification specifies target word, the advertisement will be displayed when that word is looked up. The specification will expire if the total count is reached or the end data is reached.

The sponsor account management and payment management are not part of this invention. They can be achieved with any known management methods such as used by current online companies.

Since this is an electronic dictionary, the expected features of an electronic dictionary such as wildcard search, browsing, etc. can all be supported by our dictionary. The implementation of those features is not part of this invention and not discussed here.

It is important to note that while the present invention has been described in the context of a fully functioning website, those of ordinary skill in the art will appreciate that the processes of the present invention are capable of being implemented as software in an isolated network or via wireless networks that the present invention applies equally. It can also be implemented in a standalone device that includes all components in FIG. 1. The invention can also be reduced to having only one native language, or only one foreign language, or only one native and one foreign language.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A computer-implemented online dictionary system for foreign language lookup comprising of a dictionary and a user interaction mechanism through which the user community who look up said dictionary also contribute to the word entries and the definitions in said dictionary.

2. The system of claim 1, wherein a user in said user community can use client server interaction mechanism to lookup a word, which is defined as being any correctly spelled word, incorrectly spelled word, acronym, short phrase, or any media that could be encoded with a limited sequence of bytes.

3. The system of claim 2, wherein the definitions for said word contains source language, pronunciation, definition in source language, and definition is target language; if the said word does not exist in said dictionary, a new incomplete definition will be created in said dictionary for said word.

4. The system of claim 3, wherein said user can accept, reject, update, or add new definition for said word he/she looks up; said user can also provide definitions for incomplete words in the dictionary; said user can also provide comments and feedbacks.

5. The system of claim 4, wherein the said definition of said word can be finalized based on some criteria which include when a certain consecutive acceptance feedbacks by users are received, whereby a user can no longer update a definition if it is finalized.

6. The system of claim 5, wherein the administrator who controls said dictionary can add, update, finalize, and remove information in said dictionary.

7. A computer-implemented online dictionary system for foreign language lookup whose dictionary contains words of different languages and their translations into different languages whereby the said dictionary is a single source to translate any word from any language into any other language.

8. The system of claim 7, wherein a user can provide, together with the word said user is looking up, the native language to translate into and, if said user knows, the original language of the word.

9. The system of claim 8, wherein said user receives the definitions of said word in said native language or, if said definitions do not exist but the definitions of said word in other languages exist, said definitions in said other languages.

10. A method of associating an advertisement with an online dictionary wherein the advertisement provider associates said advertisement with the information in said dictionary whereby other users receive the said advertisement together with the said information said users access.

11. The method of claim 10, wherein said advertisement can be associated with the language and word in said dictionary, to achieve which said advertisement provider sets the number of times said advertisement is associated with said language and said word, the total number of times said advertisement is received by said users, and the expiration date when said advertisement is no longer sent to said users.
